(19) United States
(12) Patent Application Publication
(10) Pub. No.: US 2011/0224076 A1
(43) Pub. Date: Sep. 15, 2011

(54) Agrochemical Formulations Comprising Three Solvents

(76) Inventor: Christian Sowa, Neustadt (DE)

(21) Appl. No.: 13/127,820

(22) PCT Filed: Nov. 2, 2009
(86) PCT No.: PCT/EP09/64420

§ 371 Date: May 5, 2011

(30) Foreign Application Priority Data
Nov. 7, 2008 (EP) 08168615.6

(51) Int. Cl. A01C 1/06; A01N 25/02; A01P 3/00; A01P 13/00; A01P 21/00; A01P 7/04; A01P 7/02

(52) U.S. Cl. 504/100; 514/784; 504/362

(57) ABSTRACT

The present invention relates to a composition comprising pesticide, solvent system and surfactant. Furthermore, the invention relates to the use of a solvent system comprising the solvents A) cyclohexanone or acetophenone, B) benzyl alcohol or 2-ethylhexanol, and C) fatty acid for producing agrochemical formulations. The invention also relates to a method for producing a composition according to the invention, comprising the mixing of pesticide and solvents A) cyclohexanone or acetophenone, B) benzyl alcohol or 2-ethylhexanol, and C) fatty acid. Also provided is the use of a composition according to the invention for controlling phytopathogenic fungi and/or undesired plant growth and/or undesired attack by insects or mites and/or for regulating the growth of plants.

The present invention relates to a composition comprising pesticide, solvent system and surfactant. Furthermore, the invention relates to the use of a solvent system comprising the solvents A) cyclohexanone or acetophenone, B) benzyl alcohol or 2-ethylhexanol, and C) fatty acid for producing agrochemical formulations. The invention also relates to a method for producing a composition according to the invention, comprising the mixing of pesticide and solvents A) cyclohexanone or acetophenone, B) benzyl alcohol or 2-ethylhexanol, and C) fatty acid. Also provided is the use of a composition according to the invention for controlling phytopathogenic fungi and/or undesired plant growth and/or undesired attack by insects or mites and/or for regulating the growth of plants. Further provided is the use of a composition according to the invention for controlling undesired attack by insects or mites on plants and/or for controlling phytopathogenic fungi and/or for controlling undesired plant growth, where seed materials of useful plants are treated with the composition. Finally, the present invention also relates to seed material treated with the composition according to the invention.

Combinations of preferred features with other preferred features are encompassed by the present invention.

Compositions comprising pesticide, solvent system and surfactant are generally known:

WO 2007/110355 discloses a liquid, nonaqueous formulation comprising pesticide, organic solvent and a surfactant mixture, where ketones, such as cyclohexanone or acetophenone, or alcohols, such as benzyl alcohol or 2-ethylhexanol, are specified as organic solvents.

WO 2002/43488 discloses an oil-in-water emulsion comprising insecticide, solvent, surfactant mixture, thickener and water, where ketones, such as cyclohexanone or acetophenone, or alcohols, such as benzyl alcohol, are specified as suitable solvents.

WO 2008/017378 discloses microemulsion concentrates comprising agrochemical active ingredients, alcoholic and nonalcoholic solvents and surfactants, where monohydric alcohols having 5 to 25 carbon atoms, carboxylic acids having 1 to 18 carbon atoms or acetophenone are specified as solvents.

DE 199 08 559 discloses emulsions comprising pesticide and nonionic emulsifiers, where oleic acid is specified as nonpolar solvent.

WO 2004/023875 discloses compositions comprising an active ingredient from the class of triazoles and a straight-chain or branched aliphatic carboxylic acid, where the molar ratio of triazole to carboxylic acid is greater than 1.

It was an object of the present invention to provide a composition comprising pesticide, solvent system and surfactant, which permits a high loading with pesticide and is stable at the same time. Stable here means that the composition and in particular the composition diluted with water has no or little tendency toward crystallization. Furthermore, it was an object that the aforementioned composition has the low crystallization tendency both for dissolved and suspended pesticides. Furthermore, it was an object to provide a composition comprising pesticide, solvent system and surfactant in the form of an emulsion concentrate which has little crystallization tendency.

The object has been achieved by a composition comprising pesticide, solvent system and surfactant, where the solvent system comprises the solvents

A) cyclohexanone or acetophenone, B) benzyl alcohol or 2-ethylhexanol, and C) fatty acid.

The composition according to the invention comprises a solvent system, which comprises the solvents A) cyclohexanone or acetophenone, B) benzyl alcohol or 2-ethylhexanol, and C) fatty acid. The composition comprises at least 40% by weight, preferably at least 50% by weight, particularly preferably at least 60% by weight, of solvent system, based on the composition. Preferably, the composition comprises 40 to 95% by weight, preferably at least 50 to 90% by weight, particularly preferably at least 60 to 90% by weight, of solvent system, based on the composition.

The solvent system usually comprises at most 35% by weight, preferably at most 25% by weight, particularly preferably 3 to 35% by weight, and in particular 7 to 25% by weight, of solvent A), based on the solvent system. In a further embodiment, the solvent system comprises at most 35% by weight, preferably at most 25% by weight, particularly preferably 3 to 35% by weight, and in particular 7 to 25% by weight, of solvent B), based on the solvent system. In a further embodiment, the solvent system comprises at least 30% by weight, preferably at least 40% by weight, particularly preferably 30 to 94% by weight, and in particular 40 to 86% by weight, of solvent C), based on the solvent system.

Preferably, the solvent system comprises 3 to 35% by weight of solvent A), 3 to 35% by weight of solvent B), and 30 to 94% by weight of solvent C); in particular 7 to 25% by weight of solvent A), 7 to 25% by weight of solvent B), and 40 to 86% by weight of solvent C). The solvent system particularly preferably comprises 3 to 35% by weight of cyclohexanone, 3 to 35% by weight of 2-ethylhexanol, and 30 to 94% by weight of fatty acid; in particular 7 to 25% by weight of solvent A), 7 to 25% by weight of solvent B), and 40 to 86% by weight of fatty acid.

Solvent A) is cyclohexanone or acetophenone, preferably cyclohexanone. Acetophenone is also known as 1-phenylethanone.
Solvent B) is benzyl alcohol or 2-ethylhexanol, preferably 2-ethylhexanol.
Solvent C) is a fatty acid. Fatty acids are usually understood as meaning linear, saturated or mono- or polyunsaturated, unsubstituted C10 to C34 carboxylic acids. In one embodiment, fatty acids are understood as meaning linear, saturated or mono- or polyunsaturated, unsubstituted C10 to C34 carboxylic acids, or a mixture of these carboxylic acids. The fatty acid may be present in pure form or in the form of mixtures of different fatty acids. The person skilled in the art draws a distinction between fatty acids and salts of fatty acids. The fatty acid is usually largely free from salts of a fatty acid, such as sodium salts or potassium salts. Preferably, the fatty acid comprises at most 3% by weight, preferably at most 1% by weight, of salt of a fatty acid. Such salts of a fatty acid cannot be used as solvents since they act as surfactants. Preferred fatty acids are those which are present in dissolved form in the solvent system in the respective amount used, preferably at 10% by weight based on the solvent system. In one embodiment, the fatty acid is a fatty acid or mixture of fatty acids which is/are present in liquid form at 20° C., such as oleic acid (m.p. 13° C.), linoleic acid (m.p, −5° C.) or linolenic acid (m.p. −11° C.). In a further embodiment, the fatty acid is a mixture of fatty acids which comprises 50 to 95% by weight, preferably 60 to 85% by weight, of oleic acid ((Z)-9-octadecenoic acid). Such mixtures are commercially available in industrial amounts, for example as Edenor® TI 05 or Edenor® PK1805 from Cognis.

In one embodiment, the composition is anhydrous. It comprises usually at most 5% by weight, preferably at most 2% by weight, particularly preferably at most 0.5% by weight and specifically at most 0.1% by weight, of water. In this embodiment, the composition comprises at least 40% by weight, preferably at least 50% by weight, particularly preferably at least 60% by weight, of solvent system, based on the composition. Preferably, the composition comprises 40 to 95% by weight, preferably at least 50 to 90% by weight, particularly preferably at least 60 to 90% by weight, of solvent system, based on the composition.

In a further embodiment, the composition comprises an aqueous phase. Here, the composition comprises at least 5% by weight, preferably at least 10% by weight, particularly preferably at least 20% by weight, of water, based on the composition. In this embodiment, the composition comprises at least 20% by weight, preferably at least 30% by weight, particularly preferably at least 40% by weight, of solvent system, based on the composition.

The term pesticide refers to at least one active ingredient selected from the group of fungicides, insecticides, nematicides, herbicides, safeners and/or growth regulators. Preferred pesticides are fungicides, insecticides and herbicides, in particular fungicides. Mixtures of pesticides of two or more of the aforementioned classes can also be used. The person skilled in the art is familiar with such pesticides, which can be found, for example, in Pesticide Manual, 14th Ed. (2006), The British Crop Protection Council, London. Suitable insecticides are insecticides from the class of carbamates, organophosphates, organochlorine insecticides, phenylpyrazoles, pyrethroids, neonicotinoids, spinosines, avermectins, milbemycins, juvenile hormone analogs, alkyl halides, organotin compounds, nereistoxin analogs, benzoylureas, diacylhydrazines, METI acaricides, and also insecticides such as chloropicrin, pymetrozine, flonicamid, clofentezine, hexythiazox, etoxazole, diafenthiuron, propargite, tetradifon, chlorfenapyr, DNOC, buprofezin, cyromazine, amitraz, hydramethylnon, acequinocyl, fluacrypyrim, rotenone, or derivatives thereof. Suitable fungicides are fungicides of the classes dinitroanilines, allylamines, anilinopyrimidines, antibiotics, aromatic hydrocarbons, benzenesulfonamides, benzimidazoles, benzisothiazoles, benzophenones, benzothiadiazoles, benzotriazines, benzyl carbamates, carbamates, carboxamides, carboxylic acid amides, chloronitriles, cyanoacetamide oximes, cyanoimidazoles, cyclopropanecarboxamides, dicarboximides, dihydrodioxazines, dinitrophenyl crotonates, dithiocarbamates, dithiolanes, ethyl phosphonates, ethyl aminothiazolecarboxamides, guanidines, hydroxyl (2-amino)pyrimidines, hydroxyanilides, imidazoles, imidazolinones, inorganics, isobenzofuranones, methoxyacrylates, methoxycarbamates, morpholines, N-phenylcarbamates, oxazolidinediones, oximinoacetates, oximinoacetamides, peptidylpyrimidine nucleosides, phenylacetamides, phenylamides, phenylpyrroles, phenylureas, phosphonates, phosphorothiolates, phthalamic acids, phthalimides, piperazines, piperidines, propionamides, pyridazinones, pyridines, pyridinylmethylbenzamides, pyrimidinamines, pyrimidines, pyrimidinonehydrazones, pyrroloquinolinones, quinazolinones, quinolines, quinones, sulfamides, sulfamoyltriazoles, thiazolecarboxamides, thiocarbamates, thiophanates, thiophenecarboxamides, toluamides, triphenyltin compounds, triazines, triazoles. Suitable herbicides are herbicides of the classes of the acetamides, amides, aryloxyphenoxypropionates, benzamides, benzofuran, benzoic acids, benzothiadiazinones, bipyridylium, carbamates, chloroacetamides, chlorcarboxylic acids, cyclohexanediones, dinitroanilines, dinitrophenol, diphenyl ether, glycines, imidazolinones, isoxazoles, isoxazolidinones, nitriles, N-phenylphthalimides, oxadiazoles, oxazolidinediones, oxyacetamides, phenoxycarboxylic acids, phenyl carbamates, phenylpyrazoles, phenylpyrazolines, phenylpyridazines, phosphinic acids, phosphoroamidates, phosphorodithioates, phthalamates, pyrazoles, pyridazinones, pyridines, pyridinecarboxylic acids, pyridinecarboxamides, pyrimidinediones, pyrimidinyl (thio)benzoates, quinolinecarboxylic acids, semicarbazones, sulfonylaminocarbonyltriazolinones, sulfonylureas, tetrazolinones, thiadiazoles, thiocarbamates, triazines, triazinones, triazoles, triazolinones, triazolocarboxamides, triazolopyrimidines, triketones, uracils, ureas.

Suitable fungicides are, for example:

A) strobilurins:
azoxystrobin, dimoxystrobin, enestroburin, fluoxastrobin, kresoxim-methyl, metominostrobin, orysastrobin, picoxystrobin, pyraclostrobin, pyribencarb, trifloxystrobin, 2-(2-(6-(3-chloro-2-methylphenoxy)-5-fluoropyrimidin-4-yloxy)phenyl)-2-methoxyimino-N-methylacetamide, 2-(ortho(2,5-dimethylphenyloxymethylene)-phenyl)-3-methoxyacrylic acid methyl ester, 3-methoxy-2-(2-(N-(4-methoxyphenyl)-cyclopropanecarboximidoylsulfanylmethyl)phenyl)acrylic acid methyl ester, 2-(2-(3-(2,6-dichlorophenyl)-1-methylallylideneaminooxymethyl)phenyl)-2-methoxyimino-N-methylacetamide;
   B) carboxamides:
carboxanilides: benalaxyl, benalaxyl-M, benodanil, bixafen, boscalid, carboxin, fenfuram, fenhexamid, flutolanil, furametpyr, isopyrazam, isotianil, kiralaxyl, mepronil, metalaxyl, metalaxyl-M (mefenoxam), ofurace, oxadixyl, oxycarboxin, penflufen (N-(2-(1,3-dimethylbutyl)phenyl)-1,3-dimethyl-5-fluoro-1H-pyrazole-4 carboxamide), penthiopyrad, sedaxane, tecloftalam, thifluzamide, tiadinil, 2-amino-4-methylthiazole-5-carboxanilide, 2-chloro-N-(1,1,3-trimethylindan-4-yl)nicotinamide, N-(3′,4′,5′-trifluorobiphenyl-2-yl)-3-difluoromethyl-1-methyl-1H-pyrazole-4-carboxamide, N-(4′-trifluoromethylthiobiphenyl-2-yl)-3-difluoromethyl-1-methyl-1H-pyrazole-4-carboxamide, N-(2-(1,3,3-trimethylbutyl)phenyl)-1,3-dimethyl-5-fluoro-1H-pyrazole-4-carboxamide;
carboxylic acid morpholides: dimethomorph, flumorph, pyrimorph;
benzamides: flumetover, fluopicolide, fluopyram, zoxamide, N-(3-ethyl-3,5,5-trimethylcyclohexyl)-3-formylamino-2-hydroxybenzamide;
other carboxamides: carpropamid, diclocymet, mandipropamid, oxytetracycline, silthiofam, N-(6-methoxypyridin-3-yl)cyclopropanecarboxamide;
   C) azoles:
triazoles: azaconazole, bitertanol, bromuconazole, cyproconazole, difenoconazole, diniconazole, diniconazole-M, epoxiconazole, fenbuconazole, fluquinconazole, flusilazole, flutriafol, hexaconazole, imibenconazole, ipconazole, metconazole, myclobutanil, oxpoconazole, paclobutrazol, penconazole, propiconazole, prothioconazole, simeconazole, tebuconazole, tetraconazole, triadimefon, triadimenol, triticonazole, uniconazole, 1-(4-chlorophenyl)-2-([1,2,4]triazol-1-yl)cycloheptanol;
imidazoles: cyazofamid, imazalil, imazalil sulfate, pefurazoate, prochloraz, triflumizole;
benzimidazoles: benomyl, carbendazim, fuberidazole, thiabendazole;
others: ethaboxam, etridiazole, hymexazol, 2-(4-chlorophenyl)-N-[4-(3,4-dimethoxyphenyl)isoxazol-5-yl]-2-prop-2-inyloxyacetamide;
   D) nitrogen-containing heterocyclyl compounds
pyridines: fluazinam, pyrifenox, 3-[5-(4-chlorophenyl)-2,3-dimethylisoxazolidin-3-yl]-pyridine, 3-[5-(4-methylphenyl)-2,3-dimethylisoxazolidin-3-yl]pyridine, 2,3,5,6-tetrachloro-4-methanesulfonylpyridine, 3,4,5-trichloropyridine-2,6-dicarbonitrile, N-(1-(5-bromo-3-chloropyridin-2-yl)ethyl)-2,4-dichloronicotinamide, N-((5-bromo-3-chloropyridin-2-yl)methyl)-2,4-dichloronicotinamide;
pyrimidines: bupirimate, cyprodinil, diflumetorim, fenarimol, ferimzone, mepanipyrim, nitrapyrin, nuarimol, pyrimethanil;
piperazines: triforine;
pyrroles: fludioxonil, fenpiclonil;
morpholines: aldimorph, dodemorph, dodemorph acetate, fenpropimorph, tridemorph;
piperidines: fenpropidin;
dicarboximides: fluorimide, iprodione, procymidone, vinclozolin;
nonaromatic 5-ring heterocycles: famoxadone, fenamidone, flutianil, octhilinone, probenazole, S-allyl 5-amino-2-isopropyl-3-oxo-4-ortho-tolyl-2,3-dihydropyrazole-1-thiocarboxylate;
others: acibenzolar-S-methyl, amisulbrom, anilazine, blasticidin-S, captafol, captan, quinomethionate, dazomet, debacarb, diclomezine, difenzoquat, difenzoquat methylsulfate, fenoxanil, folpet, oxolinic acid, piperalin, proquinazid, pyroquilon, quinoxyfen, triazoxide, tricyclazole, 2-butoxy-6-iodo-3-propylchromen-4-one, 5-chloro-1-(4,6-dimethoxypyrimidin-2-yl)-2-methyl-1H-benzoimidazole, 5-chloro-7-(4-methylpiperidin-1-yl)-6-(2,4,6-trifluorophenyl)[1,2,4]triazolo[1,5-a]pyrimidine, 5-ethyl-6-octyl[1,2,4]-triazolo[1,5-a]pyrimidin-7-ylamine;
   E) carbamates and dithiocarbamates
thio- and dithiocarbamates: ferbam, mancozeb, maneb, metam, methasulphocarb, metiram, propineb, thiram, zineb, ziram;
carbamates: diethofencarb, benthiavalicarb, iprovalicarb, propamocarb, propamocarb hydrochloride, valiphenal, N-(1-(1-(4-cyanophenyl)ethanesulfonyl)but-2-yl)carbamic acid 4-fluorophenyl ester;
   F) other fungicides
guanidines: dodine, dodine free base, guazatine, guazatine acetate, iminoctadine, iminoctadine triacetate, iminoctadine tris(albesilate);
antibiotics: kasugamycin, kasugamycin hydrochloride hydrate, polyoxins, streptomycin, validamycin A;
nitrophenyl derivatives: binapacryl, dicloran, dinobuton, dinocap, nitrothalisopropyl, tecnazene;
organometallic compounds: fentin salts such as, for example, fentin acetate, fentin chloride, fentin hydroxide;
sulfur-containing heterocyclyl compounds: dithianon, isoprothiolane;
organophosphorus compounds: edifenphos, fosetyl, fosetyl-aluminum, iprobenfos, phosphorous acid and its salts, pyrazophos, tolclofos-methyl;
organochlorine compounds: chlorthalonil, dichlofluanid, dichlorphen, flusulfamide, hexachlorobenzene, pencycuron, pentachlorophenol and its salts, phthalide, quintozene, thiophanate-methyl, tolylfluanid, N-(4-chloro-2-nitrophenyl)-N-ethyl-4-methylbenzenesulfonamide;
inorganic active ingredients: phosphorous acid and its salts, Bordeaux mixture, copper salts such as, for example, copper acetate, copper hydroxide, copper oxychloride, basic copper sulfate, sulfur;
others: biphenyl, bronopol, cyflufenamid, cymoxanil, diphenylamine, metrafenone, mildiomycin, oxine-copper, prohexadione-calcium, spiroxamine, tolylfluanid, N-(cyclopropylmethoxyimino(6-difluoromethoxy-2,3-difluorophenyl)methyl)-2-phenylacetamide, N′-(4-(4-chloro-3-trifluoromethylphenoxy)-2,5-dimethylphenyl)-N-ethyl-N-methylformamidine, N′-(4-(4-fluoro-3-trifluoromethylphenoxy)-2,5-dimethylphenyl)-N-ethyl-N-methylformamidine, N′-(2-methyl-5-trifluoromethyl-4-(3-trimethylsilanylpropoxy)phenyl)-N-ethyl-N-methylformamidine, N′-(5-difluoromethyl-2-methyl-4-(3-trimethylsilanylpropoxy)phenyl)-N-ethyl-N-methylformamidine, 2-{1-[2-(5-methyl-3-trifluoromethylpyrazol-1-yl)acetyl]piperidin-4-yl}thiazole-4-carboxylic acid methyl(1,2,3,4-tetrahydronaphthalen-1-yl)amide, 2-{1-[2-(5-methyl-3-trifluoromethylpyrazol-1-yl)acetyl]piperidin-4-yl}thiazole-4-carboxylic acid methyl-(R)-1,2,3,4-tetrahydronaphthalen-1-ylamide, acetic acid 6-tert-butyl-8-fluoro-2,3-dimethylquinolin-4-yl ester, methoxyacetic acid 6-tert-butyl-8-fluoro-2,3-dimethyl-quinolin-4-ylester, N-methyl-2-{1-[2-(5-methyl-3-trifluoromethyl-1H-pyrazol-1-yl)acetyl]piperidin-4-yl}-N-[(1R)-1,2,3,4-tetrahydronaphthalen-1-yl]-4-thiazolecarboxamide;

Suitable growth regulators are, for example:

abscisic acid, amidochlor, ancymidol, 6-benzylaminopurine, brassinolide, butralin, chlormequat (chlormequat chloride), choline chloride, cyclanilide, daminozide, dikegulac, dimethipin, 2,6-dimethylpyridine, ethephon, flumetralin, flurprimidol, fluthiacet, forchlorfenuron, gibberellic acid, inabenfid, indole-3-acetic acid, maleic hydrazide, mefluidide, mepiquat (mepiquat chloride), metconazole, naphthaleneacetic acid, N-6-benzyladenine, paclobutrazol, prohexadione (prohexadione calcium), prohydrojasmon, thidiazuron, triapenthenol, tributyl phosphorotrithioate, 2,3,5-triiodobenzoic acid, trinexapac-ethyl and uniconazole.

Suitable herbicides are, for example:
acetamides: acetochlor, alachlor, butachlor, dimethachlor, dimethenamid, flufenacet, mefenacet, metolachlor, metazachlor, napropamide, naproanilide, pethoxamid, pretilachlor, propachlor, thenylchlor;
amino acid analogs: bilanafos, glyphosate, glufosinate, sulfosate;
aryloxyphenoxypropionates: clodinafop, cyhalofop-butyl, fenoxaprop, fluazifop, haloxyfop, metamifop, propaquizafop, quizalofop, quizalofop-P-tefuryl;
bipyridyls: diquat, paraquat;
carbamates and thiocarbamates: asulam, butylate, carbetamide, desmedipham, dimepiperate, eptam (EPTC), esprocarb, molinate, orbencarb, phenmedipham, prosulfocarb, pyributicarb, thiobencarb, tri-allate;
cyclohexanediones: butroxydim, clethodim, cycloxydim, profoxydim, sethoxydim, tepraloxydim, tralkoxydim;
dinitroanilines: benfluralin, ethalfluralin, oryzalin, pendimethalin, prodiamine, trifluralin;
diphenyl ethers: acifluorfen, aclonifen, bifenox, diclofop, ethoxyfen, fomesafen, lactofen, oxyfluorfen;
hydroxybenzonitriles: bromoxynil, dichlobenil, ioxynil;
imidazolinones: imazamethabenz, imazamox, imazapic, imazapyr, imazaquin, imazethapyr;
phenoxyacetic acids: clomeprop, 2,4-dichlorophenoxyacetic acid (2,4-D), 2,4-DB, dichlorprop, MCPA, MCPA-thioethyl, MCPB, mecoprop;
pyrazines: chloridazon, flufenpyr-ethyl, fluthiacet, norflurazon, pyridate;
pyridines: aminopyralid, clopyralid, diflufenican, dithiopyr, fluridone, fluoroxypyr, picloram, picolinafen, thiazopyr;
sulfonylureas: amidosulfuron, azimsulfuron, bensulfuron, chlorimuron-ethyl, chlorsulfuron, cinosulfuron, cyclosulfamuron, ethoxysulfuron, flazasulfuron, flucetosulfuron, flupyrsulfuron, foramsulfuron, halosulfuron, imazosulfuron, iodosulfuron, mesosulfuron, metsulfuron-methyl, nicosulfuron, oxasulfuron, primisulfuron, prosulfuron, pyrazosulfuron, rimsulfuron, sulfometuron, sulfosulfuron, thifensulfuron, triasulfuron, tribenuron, trifloxysulfuron, triflusulfuron, tritosulfuron, 1-((2-chloro-6-propylimidazo[1,2-b]pyridazin-3-yl)sulfonyl)-3-(4,6-dimethoxypyrimidin-2-yl)urea;
triazines: ametryn, atrazine, cyanazine, dimethametryn, ethiozine, hexazinon, metamitron, metribuzin, prometryn, simazine, terbuthylazine, terbutryn, triaziflam;
ureas: chlortoluron, daimuron, diuron, fluometuron, isoproturon, linuron, methabenzthiazuron, tebuthiuron;
other acetolactate synthase inhibitors: bispyribac-sodium, cloransulam-methyl, diclosulam, florasulam, flucarbazone, flumetsulam, metosulam, ortho-sulfamuron, penoxsulam, propoxycarbazone, pyribambenz-propyl, pyribenzoxim, pyriftalide, pyriminobac-methyl, pyrimisulfan, pyrithiobac, pyroxasulfone, pyroxsulam;
others: amicarbazone, aminotriazole, anilofos, beflubutamid, benazolin, bencarbazone, benfuresate, benzofenap, bentazone, benzobicyclon, bromacil, bromobutide, butafenacil, butamifos, cafenstrole, carfentrazone, cinidon-ethyl, chlorthal, cinmethylin, clomazone, cumyluron, cyprosulfamide, dicamba, difenzoquat, diflufenzopyr, Drechslera monoceras, endothal, ethofumesate, etobenzanid, fentrazamide, flumiclorac-pentyl, flumioxazin, flupoxam, fluorochloridone, flurtamone, indanofan, isoxaben, isoxaflutole, lenacil, propanil, propyzamide, quinclorac, quinmerac, mesotrione, methylarsenic acid, naptalam, oxadiargyl, oxadiazon, oxaziclomefone, pentoxazone, pinoxaden, pyraclonil, pyraflufen-ethyl, pyrasulfotol, pyrazoxyfen, pyrazolynate, quinoclamine, saflufenacil, sulcotrione, sulfentrazone, terbacil, tefuryltrione, tembotrione, thiencarbazone, topramezone, 4-hydroxy-3-[2-(2-methoxyethoxymethyl)-6-trifluoromethylpyridine-3-carbonyl]bicyclo[3.2.1]oct-3-en-2-one, (3-[2-chloro-4-fluoro-5-(3-methyl-2,6-dioxo-4-trifluoromethyl-3,6-dihydro-2H-pyrimidin-1-yl)phenoxy]pyridin-2-yloxy)acetic acid ethyl ester, 6-amino-5-chloro-2-cyclopropylpyrimidine-4-carboxylic acid methyl ester, 6-chloro-3-(2-cyclopropyl-6-methylphenoxy)pyridazin-4-ol, 4-amino-3-chloro-6-(4-chlorophenyl)-5-fluoropyridine-2-carboxylic acid, 4-amino-3-chloro-6-(4-chloro-2-fluoro-3-methoxyphenyl)-pyridine-2-carboxylic acid methyl ester, and 4-amino-3-chloro-6-(4-chloro-3-dimethylamino-2-fluorophenyl)pyridine-2-carboxylic acid methyl ester.

Suitable insecticides are, for example:
organo(thio)phosphates: acephate, azamethiphos, azinphos-methyl, chlorpyrifos, chlorpyrifos-methyl, chlorfenvinphos, diazinon, dichlorvos, dicrotophos, dimethoate, disulfoton, ethion, fenitrothion, fenthion, isoxathion, malathion, methamidophos, methidathion, methyl-parathion, mevinphos, monocrotophos, oxydemeton-methyl, paraoxon, parathion, phenthoate, phosalone, phosmet, phosphamidon, phorate, phoxim, pirimiphos-methyl, profenofos, prothiofos, sulprophos, tetrachlorvinphos, terbufos, triazophos, trichlorfon;
carbamates: alanycarb, aldicarb, bendiocarb, benfuracarb, carbaryl, carbofuran, carbosulfan, fenoxycarb, furathiocarb, methiocarb, methomyl, oxamyl, pirimicarb, propoxur, thiodicarb, triazamate;
pyrethroids: allethrin, bifenthrin, cyfluthrin, cyhalothrin, cyphenothrin, cypermethrin, alpha-cypermethrin, beta-cypermethrin, zeta-cypermethrin, deltamethrin, esfenvalerate, etofenprox, fenpropathrin, fenvalerate, imiprothrin, lambda-cyhalothrin, permethrin, prallethrin, pyrethrin I and II, resmethrin, silafluofen, tau-fluva-linat, tefluthrin, tetramethrin, tralomethrin, transfluthrin, profluthrin, dimefluthrin,
insect growth inhibitors: a) chitin synthesis inhibitors: benzoylureas: chlorfluazuron, cyromazine, diflubenzuron, flucycloxuron, flufenoxuron, hexaflumuron, lufenuron, novaluron, teflubenzuron, triflumuron; buprofezin, diofenolan, hexythiazox, etoxazole, clofentezine; b) ecdysone antagonists: halofenozide, methoxyfenozide, tebufenozide, azadirachtin; c) juvenoids: pyriproxyfen, methoprene, fenoxycarb; d) lipid biosynthesis inhibitors: spirodiclofen, spiromesifen, spirotetramate;
nicotine receptor agonists/antagonists: clothianidin, dinotefuran, imidacloprid, thiamethoxam, nitenpyram, acetamiprid, thiacloprid, 1-(2-chlorothiazol-5-ylmethyl)-2-nitrimino-3,5-dimethyl[1,3,5]triazinane;
GABA antagonists: endosulfan, ethiprole, fipronil, vaniliprole, pyrafluprole, pyriprole, 5-amino-1-(2,6-dichloro-4-methylphenyl)-4-sulfinamoyl-1H-pyrazole-3-thiocarboxamide;
macrocyclic lactones: abamectin, emamectin, milbemectin, lepimectin, spinosad, spinetoram;
mitochondrial electron transport chain inhibitor (METI) I acaricides: fenazaquin, pyridaben, tebufenpyrad, tolfenpyrad, flufenerim;
METI II and III substances: acequinocyl, fluacrypyrim, hydramethylnon;
   decouplers: chlorfenapyr;
   inhibitors of oxidative phosphorylation: cyhexatin, diafenthiuron, fenbutatin oxide,
   propargite;
   insect molting inhibitors: cyromazine;
   mixed-function oxidase inhibitors: piperonyl butoxide;
   sodium channel blockers: indoxacarb, metaflumizone;
   others: benclothiaz, bifenazate, cartap, flonicamid, pyridalyl, pymetrozin, sulfur, thiocyclam, flubendiamide, chlorantraniliprole, cyazypyr (HGW86); cyenopyrafen, flupyrazofos, cyflumetofen, amidoflumet, imicyafos, bistrifluoron, and pyrifluquinazon.

In one embodiment, the pesticide comprises an insecticide, the pesticide preferably consists of at least one insecticide. In a further embodiment, the pesticide comprises a fungicide, the pesticide preferably consists of at least one fungicide. Preferred fungicides are pyraclostrobin, metconazole and epoxiconazole. In a further embodiment, the pesticide comprises a herbicide, the pesticide preferably consists of at least one herbicide. In a further embodiment, the pesticide comprises a growth regulator, the pesticide preferably consists of at least one growth regulator.

In one embodiment, at least one pesticide, preferably all of the pesticides, is/are soluble in the solvent system at 20° C. to at least 10 g/l, preferably to at least 30 g/l and particularly preferably to at least 50 g/l. The solvent system used here is the solvent system used in each case, preferably a solvent system consisting of cyclohexanone, 2-ethylhexanol and oleic acid, in particular consisting of 20% by weight of cyclohexanone, 20% by weight of 2-ethylhexanol and 60% by weight of oleic acid.

In a further embodiment, at least one pesticide is suspended in the solvent system in the form of solid particles to at least 90% by weight, preferably to at least 99% by weight, based on the pesticide. The expression “based on the pesticide” refers to all of the pesticides which the composition comprises. If the composition comprises at least two pesticides, at least one pesticide is dissolved in the solvent system to at least 90% by weight. Preferably, the pesticide is suspended in the solvent system to at least 95% by weight, particularly preferably to at least 98% by weight.

In a further embodiment, at least one pesticide is dissolved in the solvent system to at least 90% by weight, preferably to at least 99% by weight, based on the pesticide. The expression “based on the pesticide” refers to all of the pesticides which the composition comprises.

In a further embodiment, at least one pesticide has a melting point of at least 5° C., preferably at least 25° C. and particularly preferably at least 50° C. In addition, this pesticide is also preferably soluble in the solvent system at 20° C. to at least 10 g/l, preferably to at least 30 g/l and particularly preferably to at least 50 g/l.

The composition according to the invention usually comprises 0.1 to 50% by weight of pesticide, preferably 1 to 40% by weight, in particular 3 to 30% by weight, based on the composition.

The composition according to the invention comprises a surfactant, which means at least one surfactant. Surfactants are compounds which reduce the surface tension of water. Examples of surfactants are ionic (anionic or cationic) and nonionic surfactants. Preferably, the composition comprises at least two surfactants, it particularly preferably comprises one nonionic surfactant and one anionic surfactant. The quantitative ratio of nonionic to anionic surfactant is mostly 1:5 to 5:1, preferably 1:3 to 3:1.

Suitable ionic surfactants are the alkali metal, alkaline earth metal, ammonium salts of aromatic sulfonic acids, e.g. of lignin (Borresperse® grades, Borregaard, Norway), phenol, naphthalene (Morwet® grades, Akzo Nobel, USA) and dibutylnaphthalenesulfonic acid (Nekal® grades, BASF, Germany), and of fatty acids, alkyl- and alkylarylsulfonates, alkyl, lauryl ether and fatty alcohol sulfates, and also salts of sulfated hexa-, hepta- and octadecanols and of fatty alcohol glycol ethers, condensation products of sulfonated naphthalene and its derivatives with formaldehyde, condensation products of naphthalene or of naphthalenesulfonic acids with phenol and formaldehyde, polycarboxylates (Sokalan® grades, BASF, Germany) or phosphate esters of alkoxylated alcohols.

Preferred ionic surfactants are anionic surfactants. Suitable anionic surfactants are alkali metal and ammonium salts of alkyl sulfates (alkyl radical: C8 to C12), of sulfuric acid half-esters of ethoxylated alkanols (degree of ethoxylation from 4 to 30, alkyl radical: C12 to C18) and ethoxylated alkylphenols (degree of ethoxylation from 3 to 50, alkyl radical: C4 to C12), of alkylsulfonic acids (alkyl radical: C12 to C18) and of alkylarylsulfonic acids (alkyl radical: C9 to C18), or phosphate esters of an alkoxylated alcohol, specifically phosphate esters of an ethoxylated C10-16 fatty alcohol with degree of ethoxylation from 3 to 15. Suitable further anionic surfactants have proven to be compounds of the general formula (I),

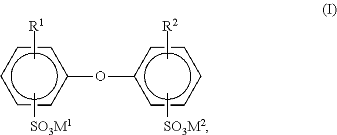

in which R1 and R2 are H atoms or C4- to C24-alkyl and are not simultaneously H atoms, and M1 and M2 may be alkali metal ions and/or ammonium ions. In the general formula (I), R1 and R2 are preferably linear or branched alkyl radicals having 6 to 18 carbon atoms, in particular having 6, 12 and 16 carbon atoms or hydrogen, where R1 and R2 are not both H atoms at the same time. M1 and M2 are preferably sodium, potassium or ammonium, with sodium being particularly preferred. Compounds (I) in which M1 and M2 are sodium, R1 is a branched alkyl radical having 12 carbon atoms and R2 is an H atom or R1 are particularly advantageous. Use is often made of technical-grade mixtures which have a fraction of from 50 to 90% by weight of the monoalkylated product, such as, for example, Dowfax® 2A1 (brand of the Dow Chemical Company). Preferred anionic surfactants are alkali metal and ammonium salts of alkylarylsulfonic acids (alkyl radical: C9 to C18), preferably linear or branched alkylbenzenesulfonic acids, and phosphate esters of an ethoxylated C10-16 fatty alcohol with degree of ethoxylation from 3 to 15.

Suitable nonionic surfactants are polyoxyethylene octyl phenol ethers, alkoxylated alcohols such as ethoxylated isooctyl-, octyl- or nonylphenol, alkylphenyl, tributylphenyl polyglycol ethers, alkylaryl polyether alcohols, isotridecyl alcohol, fatty alcohol ethylene oxide condensates, ethoxylated castor oil, polyoxyethylene or polyoxypropylene alkyl ethers, lauryl alcohol polyglycol ether acetate, sorbitol esters, lignosulfite spent liquors, and proteins, denatured proteins, polysaccharides (e.g. methylcellulose), hydrophobically modified starches, polyvinyl alcohol (Mowiol® grades, Clariant), polyalkoxylates, polvyinylamine (Lupamin® grades, BASF SE), polyethylenimine (Lupasol® grades, BASF SE), polyvinylpyrrolidone and copolymers or block polymers thereof. A suitable alkoxylated alcohol is preferably a fatty alcohol alkoxylated with ethylene oxide (EO) or propylene oxide (PO), in particular with 8 to 32, specifically with 9 to 18, carbon atoms in the fatty alcohol radical. The alkoxylated fatty alcohol has mostly a degree of ethoxylation of from 1 to 30, preferably 2 to 10 and specifically 4 to 8, ethylene oxide groups and/or a degree of propoxylation of from 1 to 30, preferably 2 to 15, and specifically 3 to 10, propylene oxide groups. The block polymer is usually a di- or triblock polymer or derivative thereof, where the polymeric fraction is composed of ethylene oxide and propylene oxide. The average molar mass is mostly at least 1000 g/mol, preferably at least 2000 g/mol. Poly(ethylene oxide-block-propylene oxide) alkyl ether with a molar mass of at least 2000 g/mol and a C₁₋₁₀-alkyl ether unit is especially suitable. Preferred nonionic surfactants are alkylphenol polyglycol ethers, tristyrylphenol ethoxylates, ethoxylated castor oil, preferably having in each case 10 to 40 ethylene oxide units per molecule.

In one embodiment, the composition according to the invention comprises 3 to 47% by weight of pesticide, 50 to 94% by weight of solvent system and 3 to 47% by weight of surfactant; preferably 4 to 33% by weight of pesticide, 60 to 89% by weight of solvent system, and 7 to 36% by weight of surfactant. In one embodiment, the composition according to the invention comprises 3 to 47% by weight of pesticide, 50 to 94% by weight of solvent system comprising 2-ethylhexanol, cyclohexanone and fatty acid, and 3 to 47% by weight of surfactant; preferably 4 to 33% by weight of pesticide, 60 to 89% by weight of solvent system comprising 2-ethylhexanol, cyclohexanone and fatty acid, and 7 to 36% by weight of surfactant.

The composition according to the invention can comprise further auxiliaries customary for agrochemical formulations, the selection of auxiliaries being governed by the specific application form and/or the active ingredient. Examples of suitable auxiliaries are additional solvents, surface-active substances (such as solubilizers, protective colloids, wetting agents and adhesives), adjuvants, organic and inorganic thickeners, bactericides, antifreezes, antifoams, dyes and stickers (e.g. for seed material handling).

Suitable as additional solvents which may be present in the solvent system as auxiliaries are organic solvents such as mineral oil fractions of medium to high boiling point, such as kerosene and diesel oil, also coal-tar oils, and oils of vegetable or animal origin, aliphatic, cyclic or aromatic hydrocarbons, e.g. paraffins, tetrahydronaphthalene, alkylated naphthalenes and derivatives thereof, alkylated benzenes and derivatives thereof, alcohols such as methanol, ethanol, propanol, butanol and cyclohexanol, glycols, ketones such as cyclohexanone, gamma-butyrolactone, dimethyl fatty acid amides, fatty acids and fatty acid esters and strongly polar solvents, e.g. amines such as N-methylpyrrolidone. In principle, it is also possible to use solvent mixtures. Preferably, at most 30% by weight, preferably at most 10% by weight, in each case based on the solvent system, and particularly preferably no additional solvents, are added to the composition according to the invention.

Suitable surface-active substances (adjuvants, wetting agents, adhesives, dispersants or emulsifiers) in addition to the aforementioned surfactants are the alkali metal salts, alkaline earth metal salts, ammonium salts of aromatic sulfonic acids, e.g. of lignin (Borresperse® grades, Borregaard, Norway), phenol, naphthalene (Morwet® grades, Akzo Nobel) and dibutylnaphthalenesulfonic acid (Nekal® grades, BASF), and also of fatty acids, alkyl- and alkylarylsulfonates, alkyl, lauryl ether and fatty alcohol sulfates, and also salts of sulfated hexa-, hepta- and octadecanols and also of fatty alcohol glycol ethers, condensation products of sulfonated naphthalene and its derivatives with formaldehyde, condensation products of naphthalene and/or of naphthalenesulfonic acids with phenol and formaldehyde, polyoxyethylene octyl phenol ether, ethoxylated isooctyl-, octyl- or nonylphenol, alkylphenyl, tributylphenyl polyglycol ethers, alkylaryl polyether alcohols, isotridecyl alcohol, fatty alcohol ethylene oxide condensates, ethoxylated castor oil, polyoxyethylene or polyoxypropylene alkyl ethers, lauryl alcohol polyglycol ether acetate, sorbitol ester, lignosulfite spent liquors, and proteins, denatured proteins, polysaccharides (e.g. methylcellulose), hydrophobically modified starches, polyvinyl alcohol (Mowiol® grades, Clariant), polycarboxylates (Sokalan® grades, BASF), polyalkoxylates, polyvinylamine (Lupamin® grades, BASF), polyethylenimine (Lupasol® grades, BASF), polyvinylpyrrolidone and copolymers thereof.

The emulsion according to the invention can comprise large amounts of surface-active substances and surfactant. It can comprise 0.1 to 40% by weight, preferably 1 to 30 and in particular 2 to 20% by weight, of the total amount of surface-active substances and surfactants, based on the total amount of the composition.

Examples of adjuvants are organically modified polysiloxanes, such as BreakThruS 240®; alcohol alkoxylates, such as Atplus®245, Atplus®MBA 1303, Plurafac®LF and Lutensol® ON; EO-PO block polymers, e.g. Pluronic® RPE 2035 and Genapol® B; alcohol ethoxylates, e.g. Lutensol® XP 80; and sodium dioctyl sulfosuccinate, e.g. Leophen® RA.

Examples of thickeners (i.e. compounds which give the composition a modified flow behavior, i.e. high viscosity in the resting state and low viscosity in the agitated state) are polysaccharides and also organic and inorganic sheet minerals such as xanthan gum (Kelzan®, CP Kelco), Rhodopol® 23 (Rhodia) or Veegum® (R.T. Vanderbilt) or Attaclay® (Engelhard Corp.).

Bactericides can be added to stabilize the composition. Examples of bactericides are those based on dichlorophen and benzyl alcohol hemiformal (Proxel® from ICI or Acticide® RS from Thor Chemie and Kathon® MK from Rohm & Haas), and isothiazolinone derivatives such as alkylisothiazolinones and benzisothiazolinones (Acticide® MBS from Thor Chemie).

Examples of suitable antifreezes are ethylene glycol, propylene glycol, urea and glycerol.

Examples of antifoams are silicone emulsions (such as e.g. Silikon® SRE, Wacker, Germany or Rhodorsil®, Rhodia, France), long-chain alcohols, fatty acids, salts of fatty acids, organofluorine compounds and mixtures thereof.

Examples of colorants are both pigments which are sparingly soluble in water and also water-soluble dyes. Examples which may be mentioned are the dyes and pigments known under the names Rhodamine B, C. I. Pigment Red 112 and C. I. Solvent Red 1, Pigment blue 15:4, Pigment blue 15:3, Pigment blue 15:2, Pigment blue 15:1, Pigment blue 80, Pigment yellow 1, Pigment yellow 13, Pigment red 48:2, Pigment red 48:1, Pigment red 57:1, Pigment red 53:1, Pigment orange 43, Pigment orange 34, Pigment orange 5, Pigment green 36, Pigment green 7, Pigment white 6, Pigment brown 25, Basic violet 10, Basic violet 49, Acid red 51, Acid red 52, Acid red 14, Acid blue 9, Acid yellow 23, Basic red 10, Basic red 108.

Examples of stickers are polyvinylpyrrolidone, polyvinyl acetate, polyvinyl alcohol and cellulose ether (Tylose®, Shin-Etsu, Japan).

Compositions according to the invention are usually present in the form of agrochemical formulations. Suitable agrochemical formulations are water-soluble concentrates (SL, LS), redispersible concentrates (DC), emulsifiable concentrates (EC), emulsions (EW, EO, ES, ME), suspensions (SC, OD, FS) or suspoemulsions (SE). The composition is preferably present in the form of an emulsifiable concentrate (EC).

The composition according to the invention is in most cases diluted prior to use in order to prepare the so-called tankmix. Of suitability for the dilution are mineral oil fractions of medium to high boiling point, such as kerosene or diesel oil, also coal-tar oils and also oils of vegetable or animal origin, aliphatic, cyclic and aromatic hydrocarbons, e.g. toluene, xylene, paraffin, tetrahydronaphthalene, alkylated naphthalenes or derivatives thereof, methanol, ethanol, propanol, butanol, cyclohexanol, cyclohexanone, isophorone, strongly polar solvents, e.g. dimethyl sulfoxide, N-methylpyrrolidone or water. Preference is given to using water. The dilute composition is usually applied by spraying or nebulizing. Oils of various types, wetting agents, adjuvants, herbicides, bactericides, fungicides can be added to the tankmix directly prior to application (tankmix). These agents can be mixed into the compositions according to the invention in the weight ratio 1:100 to 100:1, preferably 1:10 to 10:1. The pesticide concentration in the tankmix can be varied within relatively large ranges. In general, they are between 0.0001 and 10%, preferably between 0.01 and 1%. The application amounts in the case of application in crop protection are between 0.01 and 2.0 kg of active ingredient per ha depending on the nature of the desired effect.

The present invention also relates to the use of a composition according to the invention for controlling phytopathogenic fungi and/or undesired plant growth and/or undesired attack by insects or mites and/or for regulating the growth of plants, where the composition is allowed to act upon the particular pests, their habitat or the plants to be protected from the particular pest, the soil and/or on undesired plants and/or the useful plants and/or their habitat. Furthermore, the invention relates to the use of a composition according to the invention for controlling undesired attack by insects or mites on plants and/or for controlling phytopathogenic fungi and/or for controlling undesired plant growth, where seed materials of useful plants are treated with the composition.

Furthermore, the invention relates to seed material which has been treated with a composition according to the invention. The person skilled in the art understands this procedure to be the dressing of seed material. The dressing, which comprises the composition according to the invention, usually remains on the seed material. In a preferred embodiment, the invention relates to seed material which has been dressed with a composition according to the invention. Particularly preferably, the invention relates to seed material comprising a composition according to the invention. This composition can be applied to the seed material in undiluted form or, preferably, in diluted form. Here, the corresponding composition can be diluted 2 to 10-fold such that 0.01 to 60% by weight, preferably 0.1 to 40% by weight of pesticide are present in the compositions to be used for the dressing. Application can take place prior to sowing. The treatment of plant propagation material, in particular the treatment of seed material, is known to the person skilled in the art and takes place by dusting, coating, pelleting, immersing or saturating the plant propagation material, the treatment preferably taking place by pelleting, coating and dusting, in such a way that, for example, premature germination of the seed material is prevented. For the treatment of seed material, pesticide amounts of from 1 to 1000 g/100 kg, preferably 5 to 100 g/100 kg of propagation material or seed material are generally used.

The present invention also relates to the use of a solvent system comprising the solvents A) cyclohexanone or acetophenone, B) benzyl alcohol or 2-ethylhexanol, and C) fatty acid for producing agrochemical formulations. Preferred solvents and agrochemical formulations are as described above.

The present invention also relates to a method for producing the composition according to the invention, comprising the mixing of pesticide and solvents A) cyclohexanone or acetophenone, B) benzyl alcohol or 2-ethylhexanol, and C) fatty acid. Preferred solvents are as described above. The method preferably comprises the mixing of pesticide, surfactant and solvents A) cyclohexanone or acetophenone, B) benzyl alcohol or 2-ethylhexanol, and C) fatty acid. Preferred surfactants are as described above. The mixing takes place by customary mixing methods, such as stirring, shaking, or other energy input. Further auxiliaries which are used for producing agrochemical formulations can be added in customary amounts. Examples of suitable auxiliaries are as described above.

Advantages of the present invention are, inter alia, that it permits a high loading of a composition with pesticide and at the same time is stable. The composition and the water-diluted composition have no or little tendency towards crystallization. The composition is suitable both for dissolved and also suspended pesticides and in both cases has a low crystallization tendency. Compositions in the form of emulsion concentrates in particular are stable and do not have a tendency towards crystallization.

The examples below illustrate the invention without limiting it.

### EXAMPLES

Surfactant 1: Tristyrylphenol ethoxylate with 16 mol of ethylene oxide per mole (commercially available as Soprophor® BSU from Rhodia S.A.)
Surfactant 2: Phosphoric acid ester of isotridecyl alcohol ethoxylated with 6 mol of ethylene oxide (commercially available as Dispersogen® XP-060 from Clariant)
Oleic acid: liquid, technical-grade fatty acid mixture comprising a chain distribution according to ISO 5508 of 67% by weight of monounsaturated C18 fatty acid, 13% by weight of diunsaturated C18 fatty acid, 5% by weight of monounsaturated C16 fatty acid, 5% by weight of diunsaturated fatty acid; acid number 200 according to ISO660, iodine number 95 according to Wijs, cloudpoint 5° C., water content 0-0.2% by weight according to ISO 760 (commercially available as Edenor® TI 05 from Cognis).
Epoxiconazole: Purity: 95.5% by weight
Metconazole: Purity 98.8% by weight
Pyraclostrobin: Purity 99.4% by weight

### Example 1

### Formulation of Epoxiconazole

The components according to the given formulations A or B were weighed in and mixed by stirring until a clear homogeneous solution was obtained. In each case, a clear, single-phase solution of epoxiconazole was obtained.

| | | | |
|---|---|---|---|
| A) | 5.2 | g | Epoxiconazole |
| | 5.0 | g | Surfactant 1 |
| | 5.0 | g | Surfactant 2 |
| | 10.0 | g | Benzyl alcohol |
| | 10.0 | g | Cyclohexanone |
| | ad 100 | ml | Oleic acid |
| B) | 10.4 | g | Epoxiconazole |
| | 5.0 | g | Surfactant 1 |
| | 5.0 | g | Surfactant 2 |
| | 10.0 | g | Benzyl alcohol |
| | 10.0 | g | Cyclohexanone |
| | ad 100 | ml | Oleic acid |

A sample of A and B was in each case diluted with CIPAC water D (comprising 342 ppm of Ca/Mg ions) to a 1% strength by weight emulsion and left to stand for 6 hours at 20° C. During this time, no crystals of epoxiconazole were formed.

### Example 2

### Formulation of Pyraclostrobin

Emulsions A and B were prepared as described in example 1.

The sample was then diluted to a 1% strength by weight emulsion and left to stand for 6 hours at 20° C. During this time, no crystals of pyraclostrobin were formed.

| | | | |
|---|---|---|---|
| A) | 25.2 | g | Pyraclostrobin |
| | 5.0 | g | Surfactant 1 |
| | 5.0 | g | Surfactant 2 |
| | 10.0 | g | 2-Ethylhexanol |
| | 10.0 | g | Cyclohexanone |
| | ad 100 | ml | Oleic acid |
| B) | 25.2 | g | Pyraclostrobin |
| | 5.0 | g | Surfactant 1 |
| | 5.0 | g | Surfactant 2 |
| | 10.0 | g | 2-Ethylhexanol |
| | 20.0 | g | Cyclohexanone |
| | ad 100 | ml | Oleic acid |

### Example 3

### Formulation of Metconazole

An emulsion was prepared as described in example 1. A sample was then diluted to a 1% strength by weight emulsion and left to stand for 6 hours at 20° C. During this time, no crystals of pyraclostrobin were formed.

| | | |
|---|---|---|
| 15.2 | g | Metconazole |
| 5.0 | g | Surfactant 1 |
| 5.0 | g | Surfactant 2 |
| 20.0 | g | 2-Ethylhexanol |
| 10.0 | g | Cyclohexanone |
| ad 100 | ml | Oleic acid |

1. A composition comprising pesticide, solvent system and surfactant, wherein the solvent system comprises
A) cyclohexanone or acetophenone,
B) benzyl alcohol or 2-ethylhexanol, and
C) fatty acid,
where the composition comprises at most 35% by weight of solvent A), at most 35% by weight of solvent B), and at least 30% by weight of solvent C), in each case based on the solvent system, and
where at least one pesticide has a melting point of at least 5° C.

2. The composition according to claim 1, where the fatty acid is a linear, saturated or mono- or poly-unsaturated, unsubstituted C10 to C34 carboxylic acid, or a mixture of C10 to C34 carboxylic acids.

3. The composition according to claim 1, where the fatty acid is a fatty acid or mixture of fatty acids which is/are present in liquid form at 20° C.

4. The composition according to claim 1, wherein the solvent system comprises 3 to 35% by weight of solvent A), 3 to 35% by weight of solvent B), and 30 to 94% by weight of solvent C).

5. The composition according to claim 1, wherein solvent B) is 2-ethylhexanol.

6. The composition according to claim 1, wherein solvent A) is cyclohexanone.

7. The composition according to claim 1, wherein the composition comprises one nonionic surfactant and one anionic surfactant.

8. The composition according to claim 1, wherein the pesticide is dissolved in the solvent system to at least 90% by weight, based on the pesticide.

9. The composition according to claim 1, wherein the pesticide is suspended in the solvent system in the form of solid particles to at least 90% by weight, based on the pesticide.

10. The composition according to claim 1, wherein the composition comprises at least 20% by weight of water, based on the mass of the composition.

11. (canceled)

12. (canceled)

13. A method for controlling phytopathogenic fungi and/or undesired plant growth and/or undesired attack by insects or mites and/or for regulating the growth of plants, comprising allowing the composition to act on the particular pests, their habitat or the plants to be protected from the particular pest, the soil and/or on undesired plants and/or the useful plants and/or their habitat with the composition of claim 1.

14. A method for controlling undesired attack by insects or mites on plants and/or for controlling phytopathogenic fungi and/or for controlling undesired plant growth, comprising treating seed materials of useful plants with the composition of claim 1.

15. A seed treated with the composition according to claim 1.

16. The method of claim 13, where the fatty acid is a linear, saturated or mono- or poly-unsaturated, unsubstituted C10 to C34 carboxylic acid, or a mixture of C10 to C34 carboxylic acids.

17. The method of claim 13, where the fatty acid is a fatty acid or mixture of fatty acids which is/are present in liquid form at 20° C.

18. The method of claim 13, wherein the solvent system comprises 3 to 35% by weight of solvent A), 3 to 35% by weight of solvent B), and 30 to 94% by weight of solvent C).

19. The method of claim 13, wherein solvent B) is 2-ethylhexanol.

20. The method of claim 13, wherein solvent A) is cyclohexanone.

21. The method of claim 13, wherein the composition comprises one nonionic surfactant and one anionic surfactant.

22. The method of claim 13, wherein the pesticide is dissolved in the solvent system to at least 90% by weight, based on the pesticide.
